(19) United States
(12) Patent Application Publication
(10) Pub. No.: US 2008/0162755 A1
(43) Pub. Date: Jul. 3, 2008

(54) Storage apparatus and control method

(75) Inventor: Akira Minami, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/973,556

(22) Filed: Oct. 9, 2007

(30) Foreign Application Priority Data
Dec. 28, 2006 (JP) 2006-354316

(51) Int. Cl. G06F 13/00

(52) U.S. Cl. 710/74

(57) ABSTRACT

The interface changeover switch, serving as an external interface, selects any of the USB interface and the E-SATA interface. The conversion LSI reads in a changeover signal of the interface changeover switch from the GP-IO port upon turning power on, and executes signal conversion between the serial ATA interface of the hard disk drive and the USB interface, or signal conversion between the serial ATA interface of the storage device and the E-SATA interface in response to the read-in changeover signal.

This application is a priority based on prior application No. JP 2006-354316 filed Dec. 28, 2006, in Japan.

### BACKGROUND OF THE INVENTION

1. Field of the Invention

The present invention relates to a storage and a control method thereof used by changing over external interfaces of a dual configuration by switch operation. More particularly, the invention relates to a storage apparatus and a control method thereof which select, by switch changeover, an external interface and an external connection type device interface relative to a device interface of a built-in storage device.

2. Description of the Related Art

A portable type storage apparatus used by cable-connecting to a personal computer is now popularly in use. As an interface used in such a portable type storage apparatus, there is available a serial ATA interface (hereinafter referred to as a “SATA interface”) or a USB interface.

While the SATA interface has an advantage of high-rate data transmission, it is necessary to separately supply power by means of an AC adapter or the like. As compared with the SATA interface, the USB interface has a lower data transmission rate, but power can be supplied by the interface itself, and further has an advantage of not requiring a separate power supply such as an AC adapter, and of simple and easy use by cable-connecting directly to a personal computer.

As such a portable type storage apparatus, recently, a dual-interface portable storage apparatus compatible both with a SATA interface and a USB interface is proposed.

FIG. 1 illustrates a conventional portable type storage apparatus compatible with dual interfaces. In FIG. 1, in a storage apparatus 202 connected as a subsystem of a personal computer 200, there are provided a hard disk drive 204 having an SATA interface, an interface conversion LSI 206, a USB connector 208 and an external connection type serial ATA interface (an external-serial ATA called an E-SATA interface; hereinafter referred to as an E-SATA interface) connector 210. The interface conversion LSI 206 performs signal conversion between the SATA interface of the hard disk drive 204 and the E-SATA interface or the USB interface. The most remarkable feature of E-SATA is a maximum transfer rate of 150 MB/second, about 2.5 times as high as that of a USB 2.0 which is known to provide a high transfer rate. Since, in a recent HDD, data can be read out at a rate of 90 M to 130 MB/second, the USB 2.0 has formed a bottleneck in data transfer. With an E-SATA, however, it is possible to permit transfer by fully making use of the HDD performance. In more case now, therefore, an externally added device is connected via an E-SATA. Because an E-SATA is different in terminal shape from an SATA, it is necessary to provide a terminal for E-SATA. FIG. 1 shows a case where a USB interface is used: the personal computer 200 and the storage apparatus 202 are connected with a USB cable having a power line. The interface conversion LSI 206 sets the USB mode by recognizing absence of cable connection in the E-SATA interface connector 210 in initialization processing upon turning power on, and performs signal conversion between the SATA interface of the hard disk drive 204 and the USB interface of the personal computer 200.

FIG. 2 covers a case of using an E-SATA interface. In this case, the personal computer 200 and the storage apparatus 202 are connected into an E-SATA cable 214, and simultaneously, with a special USB cable 216 having only a power line to supply power to the storage apparatus by means of the USB power cable 216. In this case, the interface conversion LSI 206 sets the SAT- to SATA bypass mode by recognizing cable connection of the E-SATA interface connector 210 in initialization processing upon turning power on, and conducts signal conversion between the SATA interface of the hard disk drive 204 and the E-SATA interface of the personal computer 200. The following related patent documents are available: Utility Model Registration Publication No. 3096160; and JP No. 3-022126.

However, a problem is encountered in a storage apparatus having such a conventional dual interface in that it is necessary to activate the power supply by changing over the cable every time the interface used is changed, and this requires much time and labor.

Therefore, once an interface to be used is determined and cable connection is completed, even when it is temporarily necessary to change over the interface, use of the interface is continued as it is. It is another problem that the advantages as a dual interface cannot fully be utilized.

For some storage apparatus using an E-SATA interface as shown in FIG. 2, power supply by a USB power cable alone may result in a problem of power shortage.

### SUMMARY OF THE INVENTION

According to the present invention to provide a storage apparatus and a control method thereof which permits effective use of the advantages of a dual interface by enabling to select an external interface and an E-SATA interface as required in a state in which the cable is fixedly connected.

According to the present invention to provides also a storage apparatus and a control method thereof which permit selection of an external interface and an E-SATA interface as required even during operation after turning power on.

### (Apparatus)

The present invention provides a storage apparatus. The storage apparatus of the present invention comprises:

a storage device having a device interface;

a first external connector to which an external device having an external interface capable of supplying power is connected;

a second external connector to which an external device having an external connection type device interface is connected;

an interface changeover switch which outputs a changeover signal of the external interface or the external connection type device interface in response to a changeover operation; and

an interface conversion circuit which, in response to a changeover signal of the interface changeover switch, executes signal conversion between the device interface of the storage device and the external interface, or signal conversion between the device interface of the storage device and the external connection type device interface.

In the aforementioned storage apparatus, the interface conversion circuit comprises:

an input port to which the interface changeover switch is connected;

an external interface selecting unit which sets, in an interface selecting register, selection information of the external interface or the external connection type device interface in response to a changeover signal to the input port; and

a conversion control unit which, on the basis of the selection information set in the interface selecting register, executes signal conversion between the device interface of the storage device and the external interface, or signal conversion between the device interface of the storage device and the external connection type device interface.

The aforementioned storage apparatus further comprises:

a switch changeover detecting circuit which outputs a reset signal to the interface converting circuit by detecting a changeover of said interface changeover switch during operation after turning power on, and changes over any one of the external interface currently in selection and the external connection type device interface to the other interface.

The aforementioned storage apparatus, wherein:

The changeover switch outputs of a different level in response to the changeover position; and

the switch changeover detecting circuit comprises:

a first reset circuit which outputs a reset signal by detecting a change in falling level of the changeover signal; and

a second reset circuit which outputs a reset signal by detecting a change in rising level of the changeover signal.

The aforementioned storage apparatus, wherein:

the first reset circuit comprises:

a reverse buffer amplifier which outputs a signal of a change in rise by reversing the change in fall of the changeover signal;

an integration circuit which integrates signal of changes in rise outputted from the reverse type buffer amplifier;

a hysteresis type reverse buffer amplifier which outputs signals of changes in fall in delay by reversing an integrated voltage of the integration circuit; and

an AND circuit which outputs a reset pulse signal in synchronization with the fall of the changeover signal by means of a logical sum of the signals of changes in rise of the reverse buffer amplifier and the signals of changes in fall in delay of the hysteresis type reverse buffer amplifier; and

the second reset circuit comprises:

a buffer amplifier which outputs the signal of a change in rise of the changeover signal as it is;

an integration circuit which integrates signals of changes in rise outputted from the buffer amplifier;

a hysteresis type reverse buffer amplifier which outputs signals of changes in fall in delay by reversing the integrated voltage of the integration circuit; and

an AND circuit which outputs a reset pulse signal in synchronization with rise of the changeover signal by means of the logical sum of signals of changes in rise of the buffer amplifier and signals of changes in fall in delay of the hysteresis type reverse buffer amplifier;

and wherein:

there is provided an OR circuit which outputs a reset pulse signal to the interface conversion circuit by means of a logical sum of outputs of the AND circuits of the first reset circuit and the second reset circuit.

The aforementioned storage apparatus, wherein there is provided a power supply circuit which supplies power supplied from the external interface of the external device outputted from the first external connector as power for the entire apparatus.

The aforementioned storage apparatus may further comprise:

an external interface power line from the first external connector, which outputs power supplied from the external interface of the external device;

an AC adapter power line from the power connector, which outputs power supplied from the AC adapter; and

a power changeover switch which outputs power as a power supply for the entire apparatus by changeover-connecting to said external interface power line in conjunction with cable non-connection of the power cable and outputs power as a power supply for the entire apparatus by changeover-connecting to the AC adapter power line in conjunction with cable connection of the power connector.

The aforementioned storage apparatus may further comprise:

an external interface power line from the first external connector, which outputs USB power supplied from the external interface of the external device;

an AC adapter power line from the power connector, which outputs power supplied from the AC adapter;

a power synthetic circuit which outputs power as a power supply for the entire apparatus by commonly connecting the external interface power line and the AC adapter power line; and

a diode for preventing reverse current insert-connected to said AC adapter power line.

The aforementioned storage apparatus wherein:

the device interface is a serial ATA interface; the external interface is a USB interface; and the external connection type device interface is an external connection type serial ATA interface.

### (Methods)

The present invention provides a control method of a storage apparatus comprising:

a storage device having a device interface;

a first external connector to which an external device having an external interface to which power can be supplied is connected;

a second external connector to which an external device having an external connection type device interface is connected;

an interface changeover switch which outputs a changeover signal of the external interface or the external connection type device interface in response to a changeover operation;

an interface conversion circuit which executes signal conversion between the device interface of said storage device and the external interface, or signal conversion between the device interface of the storage device and the external connection type device interface; wherein:

any one of signal conversion between the device interface of the storage device of the interface conversion circuit and the external interface, and signal conversion between the device interface of the storage device and the external connection type device interface.

The aforementioned control method of a storage apparatus of the present invention comprises the steps of setting selection information of the external interface or the external connection type device interface in response to a changeover signal from the interface changeover switch in the interface selecting register; and executing signal conversion between the device interface of the storage device and the external interface, or signal conversion between the device interface of the storage device and the external connection type device interface, in response to the selection information set in the interface selecting register.

The control method of a storage apparatus of the present invention may further comprise, more specifically, the steps of issuing a reset signal by detecting a changeover of the interface changeover switch during operation after turning power on; and changing over any one of the external interface currently in selection and the external connection type device interface to the other interface.

The aforementioned control method of a storage apparatus may further comprise the steps of outputting a changeover signal of a different level in response to the changeover position of the interface changeover switch; outputting a change in level of fall of the changeover signal; and outputting a reset signal by detecting a change in level of rise of the changeover signal.

The control method of a storage apparatus of the present invention, wherein power supplied from the external interface of the external device outputted from the first external connector is supplied as power for the entire apparatus.

The aforementioned control method of a storage apparatus may further comprise the steps of outputting the power supplied from the external interface of the external device as power for the entire apparatus by changeover-connecting the power changeover switch to the power line from the first external connector in conjunction with non-connection of the AC adapter to the power connector; and outputting power as power for the entire apparatus by changing over the power changeover switch to the power line from the AC adapter in conjunction with cable connection of the AC adapter to the power connector.

The aforementioned control method of a storage apparatus may further comprise the steps of outputting power as power for the entire apparatus by synthesizing the power supplied from the external interface of the external device outputted from the first external connector and the power supplied from the AC adapter outputted from the power connector via the reverse current preventing diode.

According to the present invention, in a storage apparatus having a dual interface supporting two interfaces including an external interface to which power can be supplied such as a USB interface and a device interface such as an E-SATA interface, by supplying power by selecting any one of the interfaces by an interface changeover switch, a conversion mode of the switch-selected interface is set through initialization of the interface conversion circuit, thereby permitting simple and easy selection by switch operation without the need to change over the cable connection in response to the interface used.

By adding a switch changeover detecting circuit, even during use after turning power on, the initialization processing is carried out by applying reset to the interface conversion circuit through switch changeover detection. Along with this, setting is changed to the conversion mode of any of the interfaces selected by switch operation. The interfaces can thus be changed over simply and easily by the operation even during use.

The above and other objects, features, and advantages of the present invention will become more apparent from the following detailed description with reference to the drawings.

### BRIEF DESCRIPTION OF THE DRAWINGS

FIG. 1 is a descriptive view of the storage apparatus compatible with the conventional dual interfaces, illustrating a case using a USB interface.

FIG. 2 is a descriptive view of the storage apparatus compatible with the conventional dual interfaces, illustrating a case using an E-SATA interface.

FIG. 3 is a descriptive view illustrating an exterior view of the storage apparatus of an embodiment of the present invention.

FIG. 4 is a descriptive view illustrating the inner configuration of this embodiment.

FIGS. 5A and 5B are block diagrams illustrating the hardware configuration of the conversion LSI shown in FIG. 4.

FIG. 6 is a flowchart of the interface selecting processing by the conversion LSI shown in FIGS. 5A and 5B.

FIG. 7 is a descriptive view of another embodiment of the present invention permitting interface changeover in operation after turning power on.

FIGS. 8A and 8B are block diagrams illustrating the functional configuration of the conversion LSI shown in FIG. 7.

FIG. 9 is a circuit diagram of the switch changeover detecting circuit shown in FIG. 7.

FIGS. 10A to 10F are time charts illustrating operation of the first reset circuit shown in FIG. 9.

FIGS. 11A to 11F are time charts illustrating operation of the second reset circuit shown in FIG. 9.

FIG. 12 is a flow of the interface selection processing in the embodiments shown in FIGS. 7, 8A and 8B.

FIG. 13 is a descriptive view of power supply in this embodiment.

FIG. 14 is a descriptive view of another power supply in this embodiment.

### DETAILED DESCRIPTION OF THE PREFERRED EMBODIMENTS

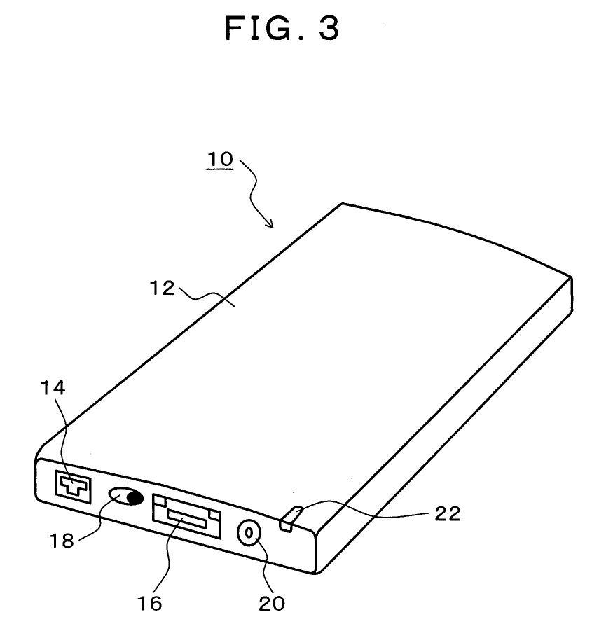

FIG. 3 is a descriptive view of a storage apparatus incorporating a portable type hard disk drive illustrating an embodiment of the present invention. The following description of embodiments covers a case where a serial ATA interface (hereinafter referred to as an “SAT interface”) serves as a device interface; a USB interface serves as an external interface to which power can be supplied; and an external connecting type serial ATA interface (hereinafter referred to as an “E-SATA interface”) serves as an external connection type device interface. In FIG. 3, the storage apparatus 10 of the present invention has a book-shaped enclosure 12 of a palm size having a thickness of about 15 to 20 mm. In front of the enclosure 12, there are provided a USB connector 14 serving as a first external connector, an E-SATA connector 16 serving as a second external connector, an interface changeover switch 18, a DC jack 20 and an LED indicator 22. A USB cable from an external device such as a personal computer is connected to the USB connector 14. When the USB cable is connected to the USB connector 14, power is supplied to the storage apparatus 10 which then becomes active. An E-SATA cable from the same personal computer is connected to the E-SATA connector 16. The interface changeover switch 18 has interface changeover positions in the USB mode and in the SATA mode. When the personal computer is turned on in the connecting state of the USB cable and the E-SATA cable in a state in which the user selects a desired changeover position, the storage apparatus 10 is started in the USB mode or the SATA mode, as selected by the interface changeover switch 18, as a result of initialization processing resulting from the power supply starting operation of the storage apparatus 10 by the power supply from the USB cable to the USB connector 14 caused by the power-on of the personal computer, thus making the selected interface active. When the power of the storage apparatus 10 is in shortage with supply of power by the USB cable by the USB connector 14, the DC jack 20 supplies power through connection of the AC adapter.

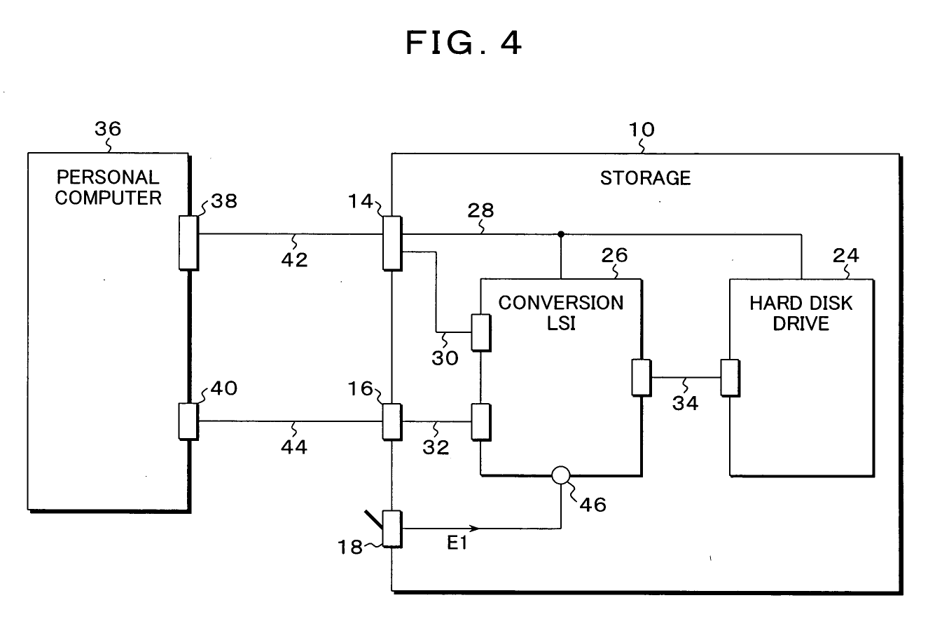

FIG. 4 is a descriptive view illustrating the internal structure of this embodiment by means of the cable connection state to the personal computer serving as an external device. In FIG. 4, the storage apparatus 10 of this embodiment is connected as a subsystem to the personal computer 36 via the USB cable 42 and the E-SATA cable 44. A hard disk drive 24 and a conversion LSI 26 are incorporated in the storage apparatus 10. The conversion LSI 26 acts as an interface converting circuit. As a conversion LSI 26, for example, an INIC610 which is a USB-to-SATA bridge made by Initio Corporation is applicable. Supply of power to the hard disk drive 24 and the conversion LSI 26 is accomplished by a USB power line 28 drawn out from the USB connector 14. A USB signal line 30 from the USB connector 14 is connected to the conversion LSI 26, and an E-SATA interface bus 32 from the E-SATA connector 16 is connected. The conversion LSI 26 has a GP-IO port 46 as a general-purpose input/output port. An interface changeover switch 18 is connected to the GP-IO port 46 to give a changeover signal E1. The term GP-IO is an abbreviation of “general-purpose I/O” and means a flexible parallel interface enabling various custom connections. The hard disk drive 24 incorporates the SATA interface and is connected to the conversion LSI 26 by the SATA bus interface 34. The personal computer 36 as an external device has a USB connector 38 and an E-SATA connector 40. It is connected to the storage apparatus 10 of the dual interfaces with two cables including the USB cable 42 and the E-SATA cable 44 to use the storage apparatus 10 as a subsystem.

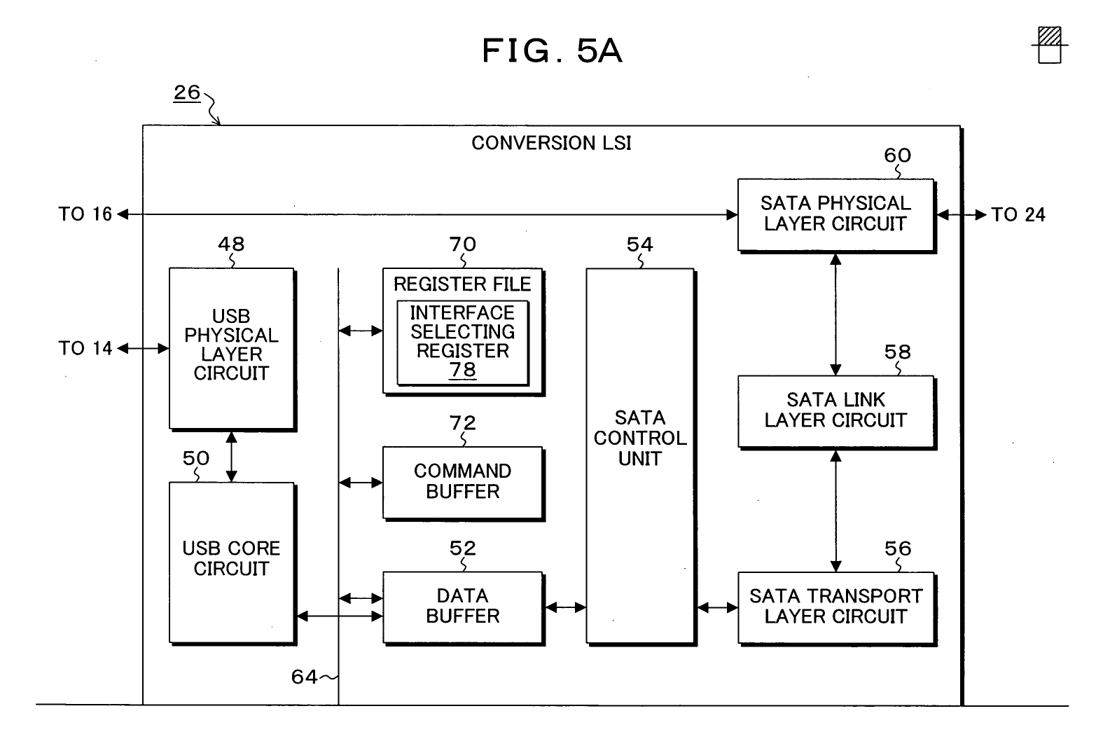

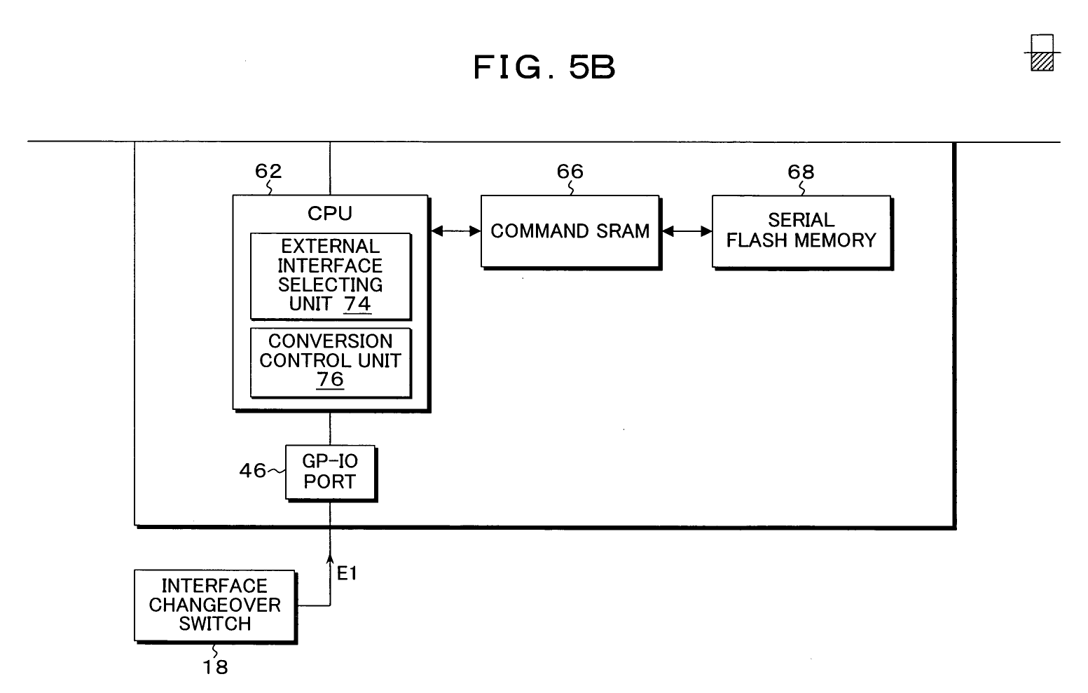

FIGS. 5A and 5B are block diagrams illustrating the hardware configuration of the conversion LSI 26 shown in FIG. 4. In FIGS. 5A and 5B, the conversion LSI 26 has, from the USB connector 14 side toward the hard disk drive 24 side, a USB physical layer circuit 48, a USB core circuit 50, a data buffer 52, an SATA control unit 54, a SATA transport layer circuit 56, an SATA link layer circuit 58 and a SATA physical layer circuit 60. In addition, a CPU 62 is provided for interface conversion control. As instruction SRAM 66 connected to the serial flash memory 68, a register file 70, a command buffer 72 and a data buffer 52 are connected to the bus 64 of the CPU. Furthermore, the CPU 62 has the GP-IO port 46 serving as a general-purpose I/O port, and the interface changeover switch 18 is connected to this GP-IO port 46. The SATA physical layer circuit 60 is connected on the one hand to a bus with the SATA interface of the hard disk drive 24, and on the other hand, to the bus for connection to the E-SATA interface of the external computer. As functions executed by program control, an external interface selecting unit 74 and a conversion control unit 76 are provided in the CPU 62. The register file 70 has an interface selecting register 78 for selecting and setting an interface. The interface selecting register 78 is read out from the serial flash memory 68 upon power-on, and arranged in the register file 70. The external interface selecting unit 74 reads out the interface selecting register 78 stored at a prescribed address in advance via the instruction SRAM 66 as a result of initialization processing upon turning power on, i.e., the boot processing of the conversion LSI 26 and arranges the thus read-out interface selecting register 78 in the register file 70. In response to the changeover signal E1 from the interface changeover switch 18 to the GP-IO port 46, the external interface selecting unit 74 writes in the selection information of either the USB interface or the E-SATA interface into the read-out and arranged interface selecting register 78. When using an INIC 11610 made by Initio Corporation as a conversion LSI 26, the function of the interface selecting register 78 can set the interface selecting mode by the use of the sixth bit of a MiscCtl register (8-bit register). Setting the sixth bit of this register at bit 0 permits selection of the USB mode, and setting at bit 1 permits setting of the SATA-to-SATA bypass mode. The conversion control unit 76 executes signal conversion with the USB interface between the SATA interface of the hard disk drive 24 and the external personal computer or signal conversion with the E-SATA interface on the basis of the interface selection information written into the interface selecting register 78 read out and arranged into the register file 70. The interface conversion control in the USB mode is performed through a path comprising, when viewing from the USB side toward the SATA side, the USB physical layer circuit 48, the USB core circuit 50, the data buffer 52, the SATA control unit 54, the SATA transport layer circuit 56, the SATA link layer circuit 58 and the SATA physical layer circuit 60. In the SATA-to-SATA bypass mode, in contrast, only the SATA physical layer circuit becomes valid. It performs conversion of a signal of the same SATA interface on the physical layer level, or more specifically, carries out bypass transfer of the SATA interface signal having bypassed the USB conversion circuit side.

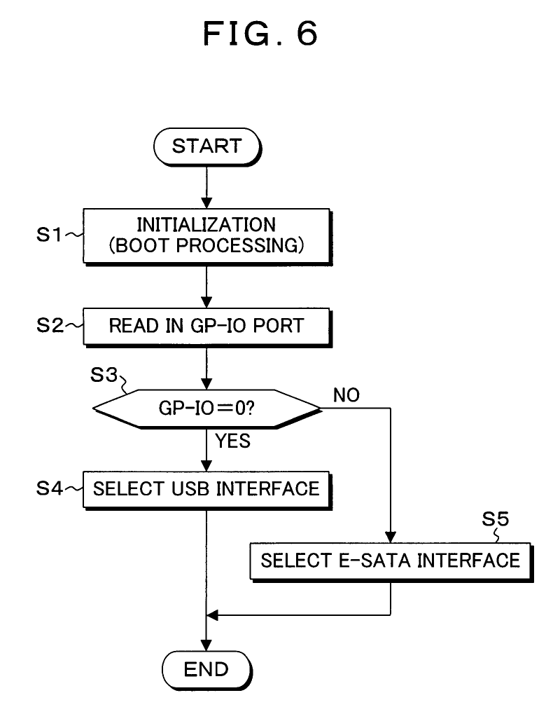

FIG. 6 is a flowchart illustrating the interface conversion processing by the conversion LSI 26 shown in FIGS. 5A and 5B. In the storage apparatus 10 of this embodiment, as shown in FIG. 4, the personal computer 36 serving as an external device is used in a state fixedly cable-connected with the USB cable 42 and the E-SATA cable 44. Prior to power-on of the personal computer 36, any of the USB mode and the SATA mode is selected in advance by the interface changeover switch 18 provided in the storage apparatus 10. When the personal computer 36 is turned on in a state in which a mode has been selected by the interface changeover switch 18, power is supplied to the storage apparatus 10 by the USB cable along with activation of the personal computer 36, and power is supplied to the hard disk drive 24 and the conversion LSI 26 through the USB power line 28 pulled out into the interior from the USB connector 14, thus achieving the active state. When power is turned on, the conversion LSI 26 reads out the interface selecting register 78 and arranges it in the register file 70 from the serial flash memory 68 via the instruction SRAM 66 under the effect of the function of the external interface selecting unit 74 provided in the4 CPU 62 as an initialization processing upon power-on, i.e., as one of the boot processes in step S1. Then in step S2, the signal level of the changeover signal E1 from the interface changeover switch 18 to the GP-IO port 46, i.e., whether the GP-IO port 46 is bit 1 or bit 0 is read in. Then in step S3, it is checked whether or not the GP-IO port 46 is bit 1. If bit 0, the process advances to step S4, in which bit 0 representing the USB mode is written into the interface selecting register 78 of the register file 70. Write of bit 0 into the interface selecting register 78 causes the conversion control unit 76 of the CPU 62 to recognize that the mode is the USB mode with reference to the fact that the interface selecting bit of the interface selecting register 78 is bit 0, and executes signal connecting operation between the USB interface and the SATA interface. In step S3, on the other hand, if the GP-IO port is bit 1, a selection bit 1 representing the SATA mode is written in the interface selecting register 78 on the register file 70. The conversion control unit 76 selects the E-SATA interface in step S5 in response to the selection bit 1 of the interface selecting register 78, activates operation of the USB physical layer circuit 48, the USB core circuit 50, the data buffer 52, the SATA control unit 54, the SATA transport layer circuit 56, the SATAA link layer circuit 58 and the SATA physical layer circuit 60 shown in FIGS. 5A and 5B, and executes interface signal conversion between the hard disk drive 24 and the external personal computer connected via the USB connector 14, i.e., signal conversion between the USB interface and the SATA interface.

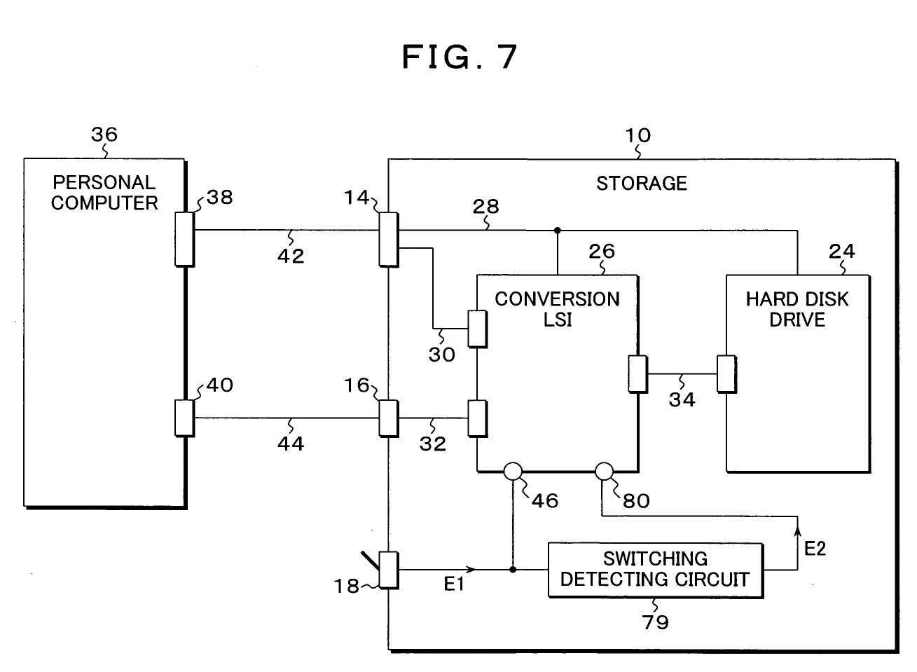

FIG. 7 is a descriptive view illustrating another embodiment of the present invention which permits interface changeover during operation after power-on. In FIG. 7, the storage apparatus 10 incorporates the hard disk drive 24 and the conversion LSI 26, and arranged as a subsystem of the external personal computer 36 through connection to the USB connector 14 via the USB cable 42 and connection to the E-SATA connector 16 via the E-SATA cable 44. The interface changeover switch 18 is provided to give a changeover signal E1 to the GP-IO port 46 of the conversion LSI 26. This configuration is the same as that of the embodiment shown in FIG. 4. In the present embodiment, however, a switch changeover detecting unit 79 is provided. The switch changeover detecting circuit 79 detects a changeover of the interface changeover switch 18 during operation after power-on, outputs a reset signal E2 to the reset port 80 of the conversion LSI 26, and through a boot processing carried out as an initialization processing, adopts either of the USB interface or the E-SATA interface currently selected by the interface changeover switch 18, to accomplish interface changeover.

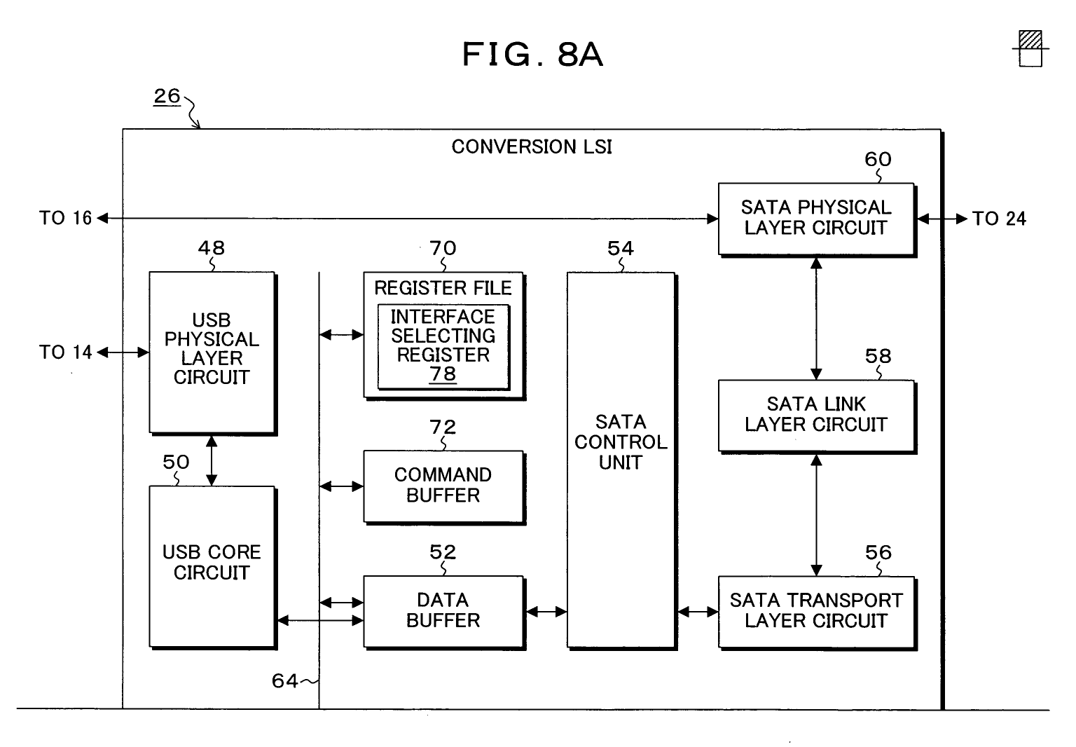

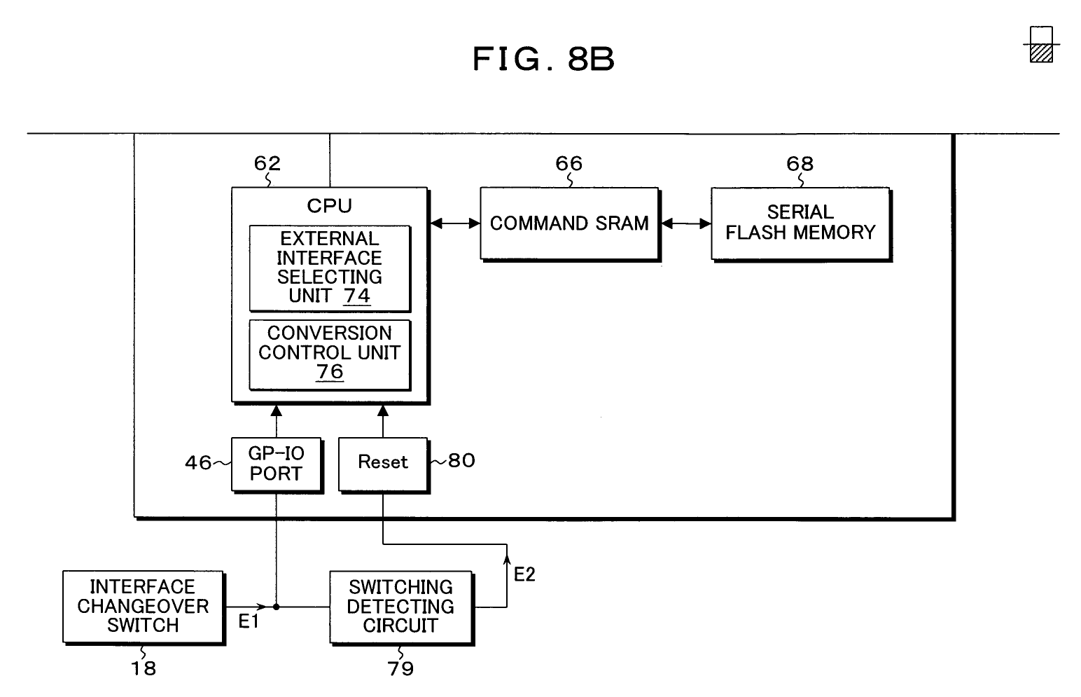

FIGS. 8A and 8B are block diagrams illustrating the hardware configuration of the conversion LSI 26. While the hardware configuration of the conversion LSI 26 shown in FIGS. 8A and 8B is basically the same as that shown in FIGS. 5A and 5B, provision of the switch changeover detecting circuit 79 additionally results in input of a reset signal E2 from the switch changeover detecting circuit 79 to the reset port 80 of the CPU 62.

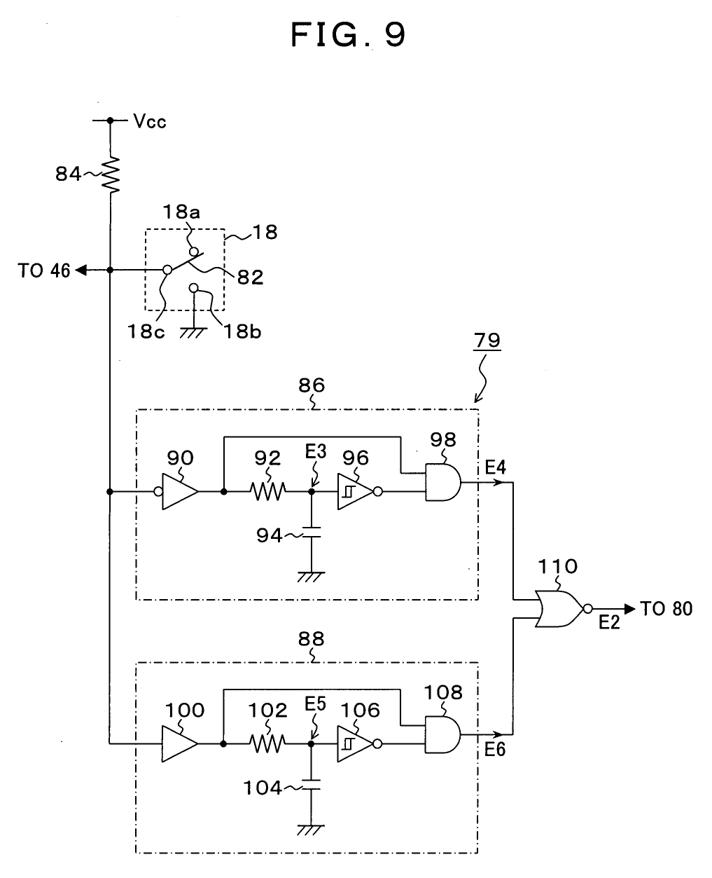

FIG. 9 is a circuit diagram illustrating an embodiment of the switch changeover circuit 79 shown in FIGS. 7, 8A and 8B. In FIG. 9, a first reset circuit 86 and a second reset circuit 88 are provided in the switch changeover detecting circuit 79. The interface changeover switch 18 has a switch contact piece 82 on a common terminal 18c changeable to either of two changeover contact points 18a and 18b. The common terminal 18c is connected to a power line via a full-up resistance 84 so as to be pulled up by the source voltage Vcc. The output line of the interface changeover switch 18 is input-connected to the first reset circuit 86 and the second reset circuit 88. The first reset circuit 86 detects that the changeover signal E1 of the interface changeover switch 18 has changed from H-level to L-level, and causes output of a reset signal. That is, in a state in which the switch contact point has just been changed over to the changeover contact point 18a shown, the changeover signal E1 is on H-level, and when the switch contact piece 82 is changed over to the changeover contact point 18b from this state, the switch changeover signal E1 falls down to L-level, and change of falling down from H-level to L-level of the switch changeover signal E1 is detected by the first reset circuit 86, thereby causing output of a reset signal. On the other hand, the second reset circuit 88 detects a rising change from L-level to H-level of the switch changeover signal E1 upon changeover of the switch contact piece 82 of the interface changeover switch 18 from the changeover terminal 18b to 18a, and outputs a reset signal E2. The first reset circuit 86 comprises, from the input side toward the output side, a reverse buffer amplifier 90, an integrating circuit composed of a resistance 92 and a capacitor 94, a hysteresis type reverse buffer amplifier 96 and AND circuits 98. The output of the reverse buffer amplifier 90 is connected to the integrating circuit composed of the resistance 92 and the capacitor 94, and simultaneously, input-connected to one of the AND circuits 98. The integral voltage E3 of the integrating circuit is entered into the hysteresis type reverse buffer amplifier 96. The hysteresis type reverse buffer amplifier 96 has two threshold values TH1 and TH2 (where TH1>TH2). The hysteresis property of the hysteresis type buffer amplifier 96 is such that when the integral voltage E3 exceeds the higher threshold value TH1, the H-level so far kept is reversed into L-level. The integral voltage E3 decreases subsequently, and upon becoming lower than the lower threshold value TH2, the level returns from L-level so far kept to H-level. The output of the reverse buffer amplifier 90 and the output of the hysteresis type reverse buffer amplifier are entered into the AND circuit 98. By computing an AND of the two outputs, the AND circuit 98 enters an output signal E4 into the NOR circuit 110, and outputs a reset signal E2 from the NOR circuit 110 to the reset port 80. The second reset circuit 88 is composed of a non-reverse buffer amplifier 100, an integrating circuit composed of a resistance 102 and a capacitor 104, a hysteresis type reverse buffer amplifier 106 and an AND circuit 108. The only difference from the first reset circuit 86 is that the reverse buffer amplifier 90 is replaced by the non-reverse buffer amplifier 100.

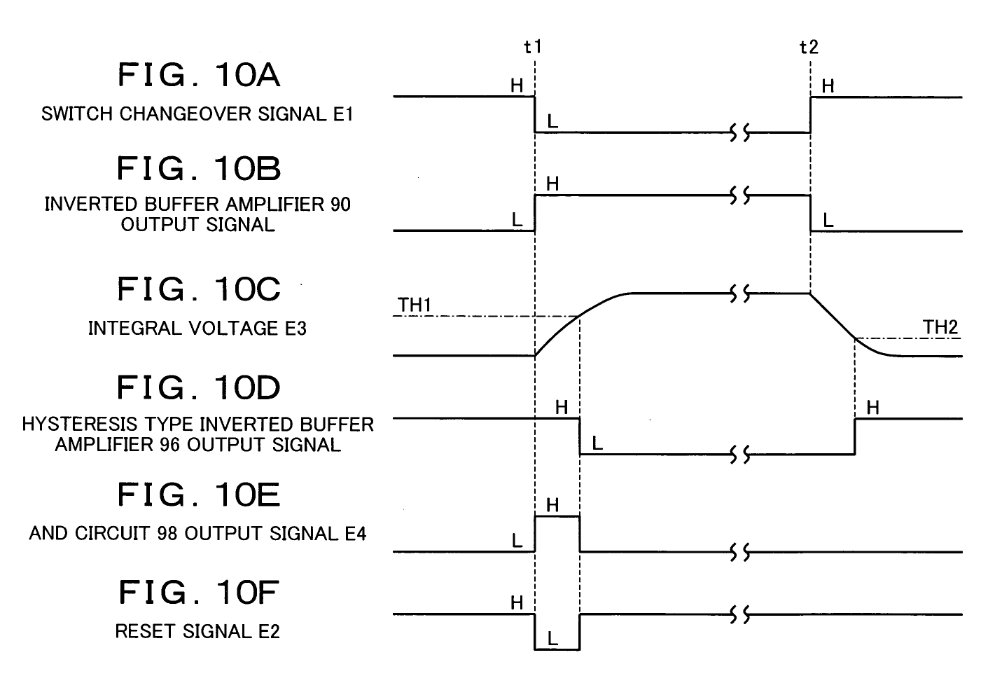

FIGS. 10A and 10B is a time chart illustrating operation of the first reset circuit 86 shown in FIG. 9. FIG. 10A represents a switch changeover signal E1: before time t1, the interface changeover switch 18 is closed toward the changeover contact point 18a side as shown in FIG. 9, and the switch changeover signal E1 is on H-level. When, in this state, the interface changeover switch 18 is changed over at time t1 on the changeover terminal 18b side, the switch changeover signal E1 falls down from H-level so far kept to L-level. As a result, the output signal of the reverse buffer amplifier 90 of the first reset circuit 86 rises from L-level so far kept to H-level, causes start of charging of the capacitor 94 via the resistance 92, and the integral voltage E3 shown in FIG. 10C begins increasing in accordance with a prescribed time constant from time t1. When the integral voltage 3 reaches the higher threshold value TH1 of the hysteresis type reverse buffer amplifier 96, it falls down from H-level so far kept to L-level as shown in FIG. 10D. When, at time t1, the switch changeover signal E1 falls down from H-level to L-level, the output signal of the reverse buffer amplifier 90 shown in FIG. 10B rises from L-level to H-level, and on the other hand, the output signal of the hysteresis type reverse buffer amplifier 90 shown in FIG. 10D keeps H-level since the integral voltage E3 does not reach the threshold value TH1. As a result, the output signal E4 of the AND circuit 98 rises to H-level from L-level at time t1. The output signal E4 of the AND circuit 98 is reversed at the NOR circuit 110. As shown in FIG. 10F, the reset signal E2 at time t1 falls down from H-level so far kept to L-level. When the integral voltage E3 shown in FIG. 10C increases along with the lapse of time, and reaches the higher threshold value TH1, the output signal of the hysteresis type reverse buffer amplifier 96 falls down from H-level to L-level as shown in FIG. 10D. As a result, the output signal E4 of the AND circuit 98 falls down from H-level so far kept to L-level as shown in FIGS. 10A to 10F, and the reset pulse signal E2 shown in FIG. 10F, in contrast, rises up from L-level to H-level. As described above, in synchronization with fall from H-level to L-level of the switch changeover signal E1 of the interface changeover switch 8, a reset pulse signal E2 having a pulse width dependent upon the integrating circuit and the hysteresis type reverse buffer amplifier 96 is outputted. Time t2 represents the operation of the first reset circuit 86 at the moment when the interface changeover switch 18 is changed over from the changeover contact points 18b to 18a, and the switch changeover signal E1 changes from L-level to H-level. At this point in time, the output signal of the reverse buffer amplifier 90 shown in FIG. 10B falls down from H-level so far kept to L-level. As a result, the integral voltage E3 begins decreasing in accordance with the time constants of the resistance 92 and the capacitor 94. When it becomes lower than the lower threshold value TH2, the output signal of the hysteresis type reverse buffer amplifier 96 shown in FIG. 10D rises up from L-level so far kept to H-level. However, for the rise of the switch changeover signal E1 at time t2 from L-level to H-level, the input to the AND circuit 98 shows only (L, L) and (L, H). The output signal E4 of the AND circuit 98 keeps the L-level state, and in this case, no reset signal E2 is outputted from the NOR circuit 110.

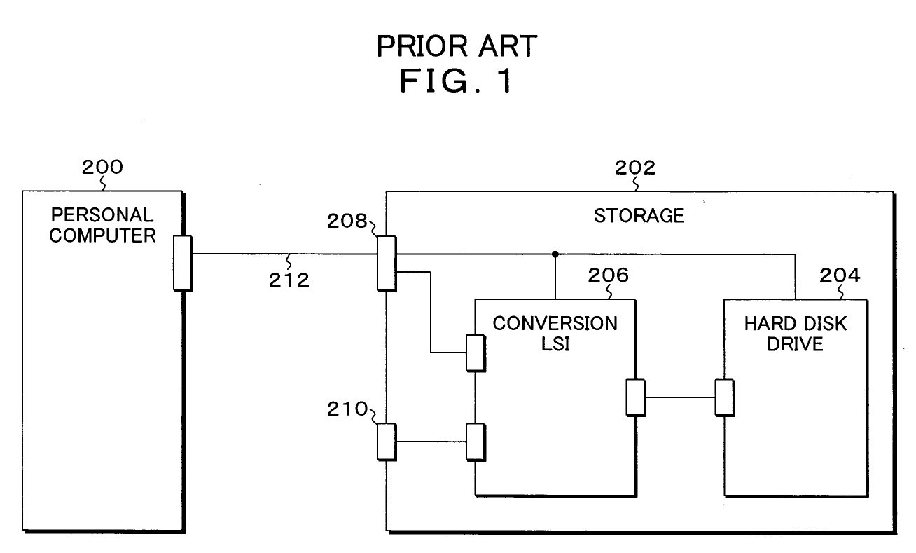

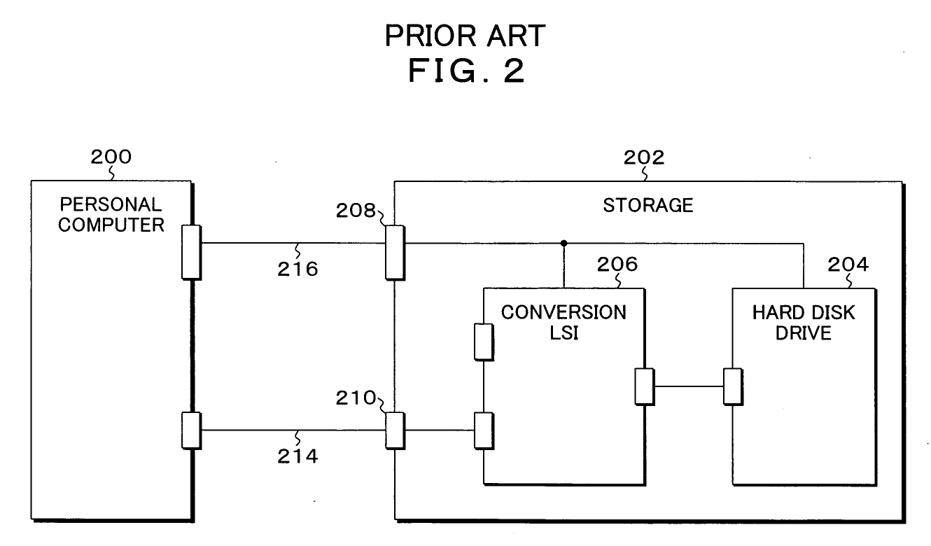

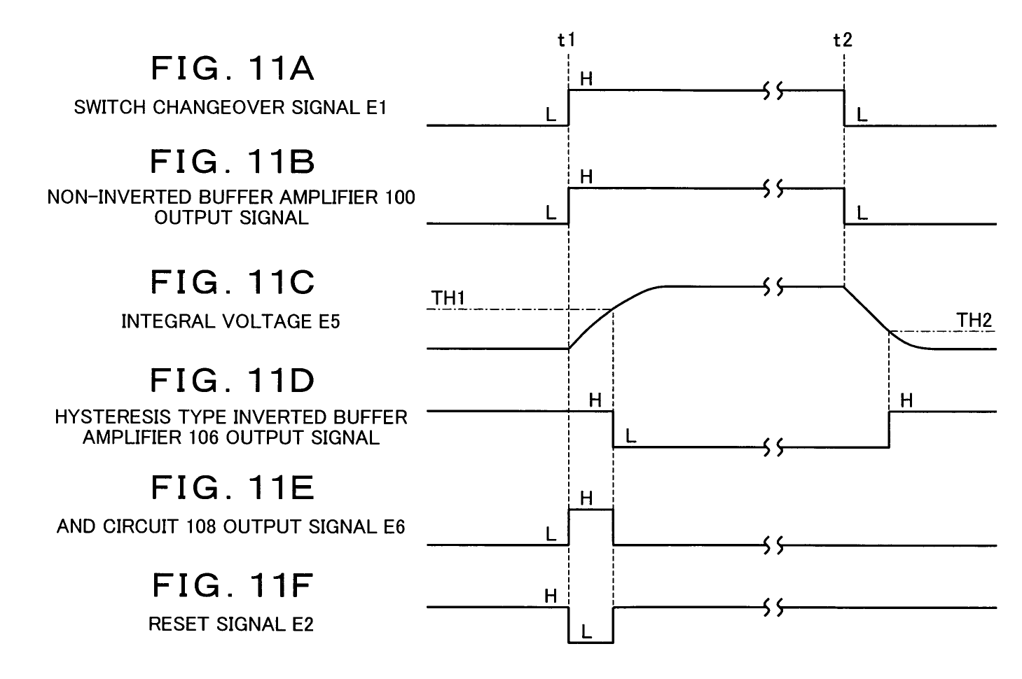

FIGS. 11A to 11F are time charts illustrating the operation of the second reset circuit 88 shown in FIG. 9. In the second reset circuit 88 shown in FIGS. 11A to 11F, by changing over the interface changeover switch 18 shown in FIG. 9 from the changeover terminals 18b to 18a at time t1, the level rises from L-level up to H-level. This switch changeover signal outputted as it is from the buffer amplifier 10, and the level rises from L-level up to H-level as shown in FIG. 11B. The output signal of the non-reverse buffer amplifier 100 charges the capacitor 104 via the resistance 102, and this causes the integral voltage E5 to begin increasing from time t1. Upon exceeding the higher threshold value TH1, the output signal of the hysteresis type reverse buffer amplifier 106 falls from H-level so far kept down to L-level. As a result, the output of the AND circuit 98 becomes (H, H) from time t1 until the integral voltage 5 exceeds the threshold value TH1, and as shown in FIG. 1E, the output signal E6 of the AND circuit 108 once rises from L-level, and then falls down again to L-level. Consequently, the reset signal E2 with which the level once falls from H-level to L-level as shown in FIG. 11F, and then returns to H-level is outputted from the NOR circuit 110. Time t2 represents a case where the switch changeover signal E1 falls from H-level down to L-level. In synchronization with this, the output signal of the buffer amplifier 100 shown in FIG. 11B also falls from H-level down to L-level. The integral voltage E3 shown in FIG. 11C begins decreasing from time t1, and upon becoming lower than the lower threshold value TH2, the output signal of the hysteresis type reverse buffer amplifier 106 shown in FIG. 11D rises from L-level up to H-level. However, the input status to the AND circuit 108 from time t2 includes (L, L) and (L, H), and the output signal E6 of the AND circuit 108 beeps L-level. The reset signal E2 shown in FIG. 11F is not therefore outputted.

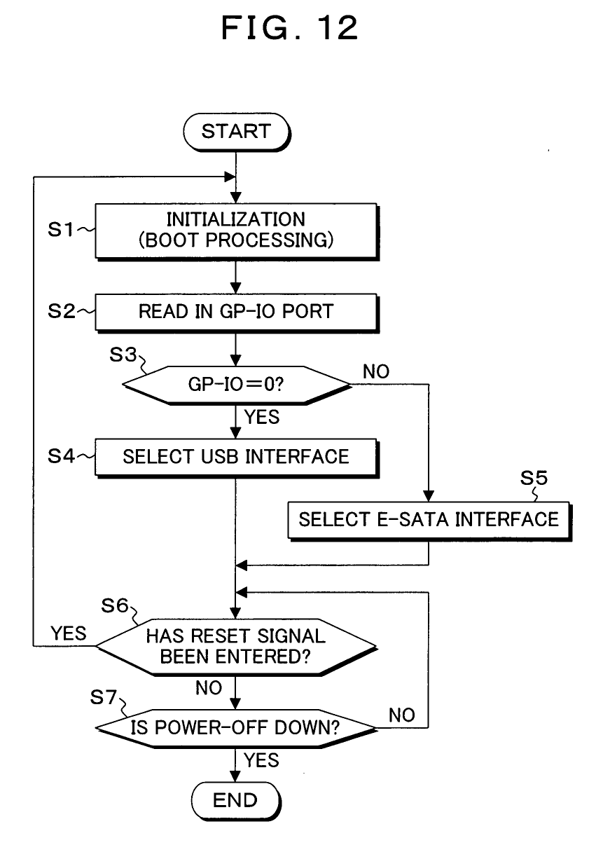

FIG. 12 is a flowchart of the interface selection processing in the embodiment shown in FIGS. 7, 8A and 8B. In FIG. 12, the interface selection processing upon power-on is the same as that in the embodiment shown in FIGS. 5A and 5B represented in the flowchart of FIG. 6. That is, as shown in FIG. 7, in a state in which the storage apparatus 10 is cable-fixed to the personal computer 36, either the USB mode or the E-SATA mode is selected in advance by means of the interface changeover switch 18 prior to power-on. When power is supplied to the personal computer 36 in this state, the storage apparatus 10 becomes active in response to the supply of power through the USB cable 42. Along with rise resulting from power-on, the interface selecting register 78 is read out from the serial flash memory 68 into the register file 70 through the boot processing during initialization processing performed in step S7 shown in FIG. 12 and arranged there. The external interface selecting unit 74 of the CPU 62 reads in the status of the changeover signal E of the interface changeover switch 18 to the GP-IO port 46, i.e., whether the bit is bit 1 or bit 0, in step S2. If the GP-IO port is bit 0 in step S3, the process advances to step S4, in which the USB interface is selected. More specifically, the external interface selecting control 74 reads in bit 0 of the GP-IO port, and writes in bit 0 as selection information of the US mode into the interface selection bit of the interface selecting register 78. The conversion control unit 76 recognizes it and executes conversion control for signal-converting from the SATA interface of the hard disk drive 24 into the USB interface. On the other hand, when it is determined that the GPIO port 46 is bit 1 representing the SATA mode in step S3, the E-SATA interface is selected in step S5. In other words, bit 1 is the SATA mode selection information is written in the interface selecting bit of the interface selecting register 78. The conversion control unit 76 recognizes the fact, and executes signal conversion between the SATA interface of the hard disk drive 24 deeming only the SATA physical layer circuit 60 shown in FIGS. 8A and 8B as valid and the E-SATA interface of the external personal computer. Upon the completion of the process of steps S1 to S4 resulting from power-on whether or not the reset signal has been entered into the reset port 80 is checked in step S6. When the user changes over the mode so far applied of the interface changeover switch 18 to another mode for changing over the interface during operation after power-on, the reset signal E2 is given from the switch changeover detecting circuit 79 to the reset port 80 of the CPU 62, and input of the reset signal is determined in step S6. When input of the reset signal is determined in step S6, the process returns to step S1. Through the boot processing in the same initialization processing as upon power-on, the information whether the status of the changeover signal E1 from the interface changeover switch 18 to the GP-IO port 46 is bit 0 or bit 1 is read in as step S4. If bit 0, the USB interface is selected in step S4. If bit 1, the E-SATA interface is selected in step S5. Bit 1 which is the selection information of the SATA mode is therefore written into the interface selection bit of the interface selecting register 79. The conversion between the SATA interface of the hard disk drive 24 deeming valid only the SATA physical layer circuit 76 and the E-SATA interface of the external personal computer. By thus providing the switch changeover detecting circuit 79, it is possible to easily changeover the mode between the USB mode and the SATA mode as required by a changeover operation of the interface changeover switch during operation after power-on.

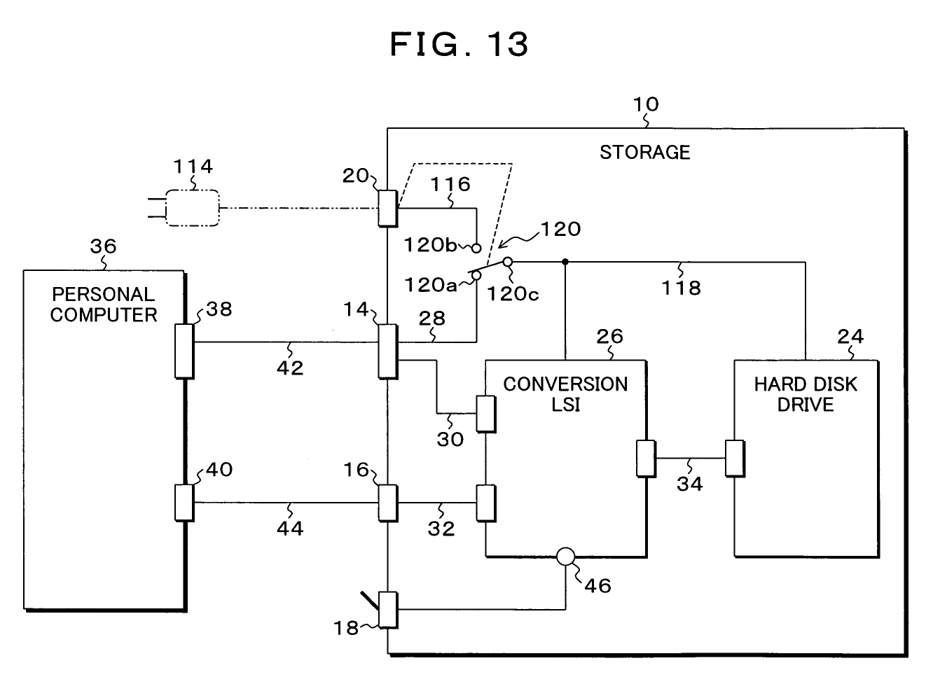

FIG. 13 is a descriptive view of supply of power in this embodiment. In FIG. 13, a DC jack 20 is provided in the storage apparatus 10 as shown in FIG. 3. In addition to supply of power through the USB power line 28 of the USB connector 14, power can be supplied to the AC adapter power line by connecting the SC adapter to the DC jack 20. As supply of power to the entire storage apparatus 10 including the hard disk drive 24 and the conversion LSI 26, in this embodiment, a power supply changeover switch 120 is provided. The power supply changeover switch 120 is formed by connecting the USB power line 28 to the changeover terminal 120a, connecting the AC adapter power line 116 to the changeover terminal 120b, and pulling out the power line 118 for supplying power for the hard disk drive 24 and the conversion LSI 26 from a common output terminal 120c. The power supply changeover switch 120 is changed over in conjunction with attachment and detachment of the AC adapter 114 to and from the DC jack 20. In a state in which the AC adapter is not connected to the DC jack 20, the power supply changeover switch 120 is changed over to the changeover terminal 120a side as shown in FIG. 13, to carry out supply of power to the entire storage apparatus from the USB power line 28. When the AC adapter 114 is connected to the DC jack 20, the power supply changeover switch 120 is changed over to the changeover terminal 120 b side in conjunction with it, and power is supplied to the entire apparatus from the AC adapter power line 116. As compared with supply of power through the USB power line 28 by the connection of the USB cable 42 from the personal computer 36, supply of power through the AC adapter 114 is larger in supplied power. Therefore, when supply of power by the USB power supply may lead to power shortage for the storage apparatus 10, it suffices to supply power by means of the AC adapter 114. When supply of power by the USB power supply from the personal computer 36 may result in power shortage, the SC adapter 114 may be connected.

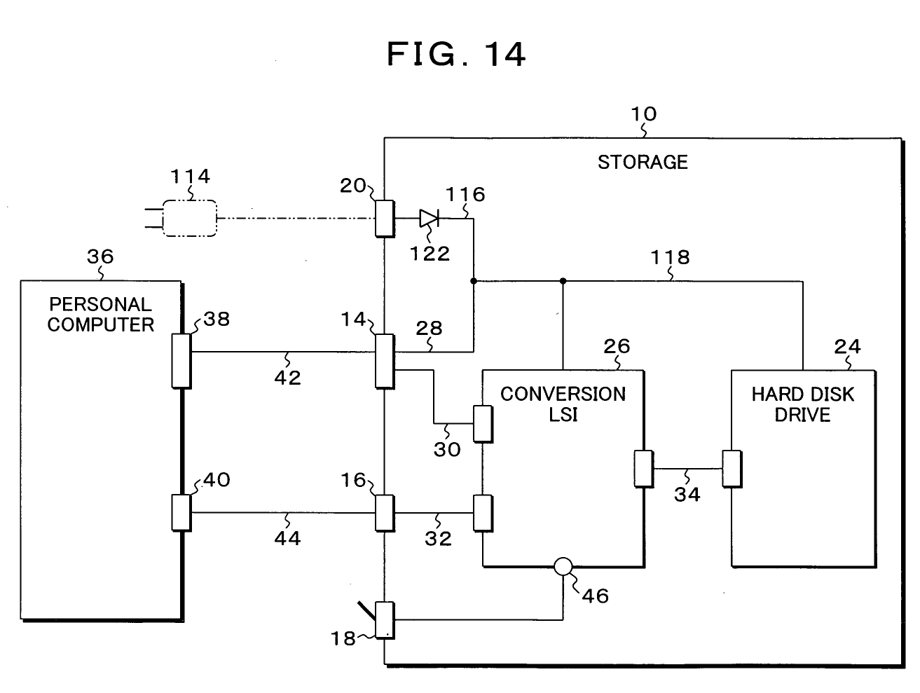

FIG. 14 is a descriptive view of other supply of power in this embodiment. This embodiment is characterized by supply of power based on the combination of the USB power supply and the AC adapter power supply for the entire storage apparatus 10. In FIG. 14, power is supplied to the storage apparatus 10 both through the USB power line 28 from the USB connector 14 and through the AC adapter power line 16 from the DC jack 20. A power supply line 118 for the entire apparatus including the hard disk drive 24 and the conversion LSI 26 is therefore pulled out by synthetically connecting the USB power line 28 and the AC adapter power line 116. Further, a counter current preventing diode 122 is insertion-connected to the AC adapter power line 116 pulled out from the DC jack 20. The diode 122 is insertion-connected with the DC jack 20 on the cathode side and the connecting side as the USB power line 28 on the anode side. In this embodiment, in a state in which the AC adapter 114 is not connected to the DC jack 20, only supply of USB power is performed through the USB cable 42 by the personal computer 36. If the AC adapter 114 is connected to the DC jack 20, power would be supplied from the power line 118 through synthesis of supply of power from the AC adapter 114 and supply of power from the USB cable 42. When the AC adapter 114 is connected to the DC jack, and if the source voltage of the USB power line 28 becomes higher than the source voltage of the AC adapter power line 116, current flows from the USB power line 28 to the AC adapter power line 116 side, causing an unnecessary power consumption. Current flow from the USB power line 28 is therefore prevented by connecting a diode to the AC adapter power line 116. The embodiment described above covers a case where both the USB cable 42 and the E-SATA interface cable 44 are fixedly connected, and any one of the dual interfaces is selectively used in response to the changeover device of the interface changeover switch 18. Apart from this, when connection is based only on the USB cable 42, the USB interface can be selectively used. When only the E-SATA interface cable 44 is connected, in contrast, only the SATA interface can be selected for use by connecting the AC adapter 114 to the DC jack 20. In the aforementioned embodiment, the INIC-1610 is used as a conversion LSI 26 composing the interface conversion circuit. This embodiment is not however limited to this, but any appropriate conversion LSI is applicable so far as it has a general-purpose I/O port functioning as an interface conversion bridge compatible with the dual interfaces supporting both the USB interface and the SATA interface. In the above-mentioned embodiment, an SATA interface is used as a device interface, and a USB interface and an E-SATA interface are used as an external changeover dual interfaces. The present invention is not however limited to this combination, but is applicable to any appropriate dual interfaces with no modification.

The present invention includes appropriate variations not impairing the object and advantages, and is not limited by numerical values shown in the aforementioned embodiment.

1. A storage apparatus comprising:
a storage device having a device interface;
a first external connector to which an external device having an external interface capable of supplying power is connected;
a second external connector to which an external device having an external connection type device interface is connected;
an interface changeover switch which outputs a changeover signal of said external interface or said external connection type device interface in response to a changeover operation; and
an interface conversion circuit which, in response to a changeover signal of said interface changeover switch, executes signal conversion between the device interface of said storage device and said external interface, or signal conversion between the device interface of said storage device and said external connection type device interface.

2. The storage apparatus according to claim 1, wherein:
said interface conversion circuit comprises:
an input port to which said interface changeover switch is connected;
an external interface selecting unit which sets, in an interface selecting register, selection information of the external interface or the external connection type device interface in response to a changeover signal to said input port; and
a conversion control unit which, on the basis of the selection information set in said interface selecting register, executes signal conversion between the device interface of said storage device and said external interface, or signal conversion between the device interface of said storage device and said external connection type device interface.

3. The storage apparatus according to claim 1, further comprising:
a switch changeover detecting circuit which outputs a reset signal to said interface converting circuit by detecting a changeover of said interface changeover switch during operation after turning power on, and changes over any one of the external interface currently in selection and the external connection type device interface to the other interface.

4. The storage apparatus according to claim 1, wherein:
the changeover switch outputs of a different level in response to the changeover position; and
said switch changeover detecting circuit comprises:
a first reset circuit which outputs a reset signal by detecting a change in falling level of said changeover signal; and
a second reset circuit which outputs a reset signal by detecting a change in rising level of said changeover signal.

5. The storage apparatus according to claim 1, wherein:
said first reset circuit comprises:
a reverse buffer amplifier which outputs a signal of a change in rise by reversing the change in fall of said changeover signal;
an integration circuit which integrates signal of changes in rise outputted from said reverse type buffer amplifier;
a hysteresis type reverse buffer amplifier which outputs signals of changes in fall in delay by reversing an integrated voltage of said integration circuit; and
an AND circuit which outputs a reset pulse signal in synchronization with the fall of said changeover signal by means of a logical sum of the signals of changes in rise of said reverse buffer amplifier and the signals of changes in fall in delay of said hysteresis type reverse buffer amplifier; and
said second reset circuit comprises:
a buffer amplifier which outputs the signal of a change in rise of said changeover signal as it is;
an integration circuit which integrates signals of changes in rise outputted from said buffer amplifier;
a hysteresis type reverse buffer amplifier which outputs signals of changes in fall in delay by reversing the integrated voltage of said integration circuit; and
an AND circuit which outputs a reset pulse signal in synchronization with rise of said changeover signal by means of the logical sum of signals of changes in rise of said buffer amplifier and signals of changes in fall in delay of said hysteresis type reverse buffer amplifier;
and wherein:
there is provided an OR circuit which outputs a reset pulse signal to said interface conversion circuit by means of a logical sum of outputs of the AND circuits of said first reset circuit and said second reset circuit.

6. The storage apparatus according to claim 1, wherein there is provided a power supply circuit which supplies power supplied from the external interface of the external device outputted from said first external connector as power for the entire apparatus.

7. The storage apparatus according to claim 1, further comprising:
an external interface power line from said first external connector, which outputs power supplied from the external interface of the external device;
an AC adapter power line from the power connector, which outputs power supplied from the AC adapter; and
a power changeover switch which outputs power as a power supply for the entire apparatus by changeover-connecting to said external interface power line in conjunction with cable non-connection of said power cable and outputs power as a power supply for the entire apparatus by changeover-connecting to said AC adapter power line in conjunction with cable connection of said power connector.

8. The storage apparatus according to claim 1, further comprising:
an external interface power line from said first external connector, which outputs USB power supplied from the external interface of the external device;
an AC adapter power line from the power connector, which outputs power supplied from the AC adapter;
a power synthetic circuit which outputs power as a power supply for the entire apparatus by commonly connecting said external interface power line and the AC adapter power line; and
a diode for preventing reverse current insert-connected to said AC adapter power line.

9. The storage apparatus according to claim 1, wherein:
said device interface is a serial ATA interface; said external interface is a USB interface; and said external connection type device interface is an external connection type serial ATA interface.

10. A control method of a storage apparatus comprising:
a storage device having a device interface;
a first external connector to which an external device having an external interface to which power can be supplied is connected;
a second external connector to which an external device having an external connection type device interface is connected;
an interface changeover switch which outputs a changeover signal of said external interface or said external connection type device interface in response to a changeover operation;
an interface conversion circuit which executes signal conversion between the device interface of said storage device and said external interface, or signal conversion between the device interface of said storage device and said external connection type device interface; wherein:
any one of signal conversion between the device interface of said storage device of said interface conversion circuit and said external interface, and signal conversion between the device interface of said storage device and said external connection type device interface.

11. The control method of a storage apparatus according to claim 10, comprising the steps of setting selection information of the external interface or the external connection type device interface in response to a changeover signal from said interface changeover switch in the interface selecting register; and executing signal conversion between the device interface of said storage device and said external interface, or signal conversion between the device interface of said storage device and said external connection type device interface, in response to the selection information set in said interface selecting register.

12. The control method of a storage apparatus according to claim 10, further comprising the steps of issuing a reset signal by detecting a changeover of said interface changeover switch during operation after turning power on; and changing over any one of the external interface currently in selection and the external connection type device interface to the other interface.

13. The control method of a storage apparatus according to claim 10, further comprising the steps of outputting a changeover signal of a different level in response to the changeover position of said interface changeover switch; outputting a change in level of fall of said changeover signal; and outputting a reset signal by detecting a change in level of rise of said changeover signal.

14. The control method of a storage apparatus according to claim 10, wherein power supplied from the external interface of the external device outputted from said first external connector is supplied as power for the entire apparatus.

15. The control method of a storage apparatus according to claim 10, further comprising the steps of outputting the power supplied from the external interface of the external device as power for the entire apparatus by changeover-connecting the power changeover switch to the power line from said first external connector in conjunction with non-connection of the AC adapter to the power connector; and outputting power as power for the entire apparatus by changing over said power changeover switch to the power line from the AC adapter in conjunction with cable connection of the AC adapter to said power connector.

16. The control method of a storage apparatus according to claim 10, further comprising the steps of outputting power as power for the entire apparatus by synthesizing the power supplied from the external interface of the external device outputted from said first external connector and the power supplied from the AC adapter outputted from the power connector via the reverse current preventing diode.

17. The control method of the storage apparatus according to claim 1, wherein:
said device interface is a serial ATA interface; said external interface is a USB interface; and furthermore, said external connection type device interface is an external connection serial ATA interface.
